(19) United States
(12) Patent Application Publication
(10) Pub. No.: US 2005/0006866 A1
(43) Pub. Date: Jan. 13, 2005

(54) Scooter folding structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/614,162

(22) Filed: Jul. 8, 2003

(51) Int. Cl. B62M 1/00

(52) U.S. Cl. 280/87.05

(57) ABSTRACT

A scooter folding structure includes a frame and a front strut. The frame has a pair of fork boards at the front end, and the front strut comprises a supporting rod protruding from the lower end. The supporting rod has a connecting section pivotally connected to the fork boards of the frame by a pivot. A block with round smooth angles at four ends is secured to the top of a connecting area between the connecting section of the supporting rod and the fork boards of the frame.

### FIELD OF THE INVENTION

This invention relates to a scooter folding structure, and more particularly to a scooter with a block to prevent a user's finger from pinching.

### BACKGROUND OF THE INVENTION

A conventional scooter, as shown in FIG. 3, includes a frame 6 and a front strut 7. The frame 6 comprises a pair of fork boards 61 at the front end, and the front strut 7 has a supporting rod 71 protruding from the lower end. The supporting rod 71 has a connecting section 711 to be inserted into the fork boards 61 of the frame 6 and secured by a shaft 8 thereat.

The supporting rod 71 of the front strut 7 is able to rotate downward or upward with respect to the frame 6, as shown in FIG. 4. However, the rotation of the front strut 7 may cause a user's finger pinched accidentally in the connecting area 9 between the connecting section 711 and the fork boards 61.

Therefore, the inventor has invented the present invention to improve the above-mentioned and many other shortcomings.

### SUMMARY OF THE INVENTION

It is the primary object of the present invention to provide a scooter folding structure, which is safe in operation.

It is another object of the present invention to provide the scooter folding structure, which corresponds to the state of art product.

It is a further object of the present invention to provide the scooter folding structure, which is inexpensive in producing.

### BRIEF DESCRIPTION OF THE DRAWINGS

FIG. 1 is a side view of the present invention;

FIG. 2 is a top view of FIG. 1;

FIG. 3 is a side view of a prior art, and

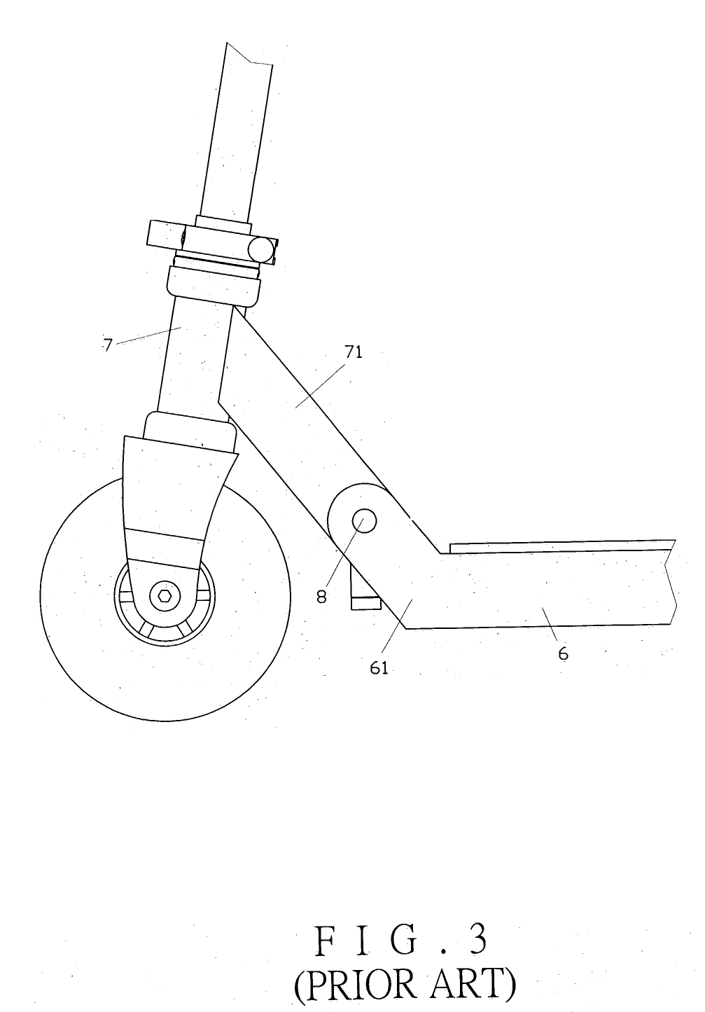

FIG. 4 is a top view of FIG. 3.

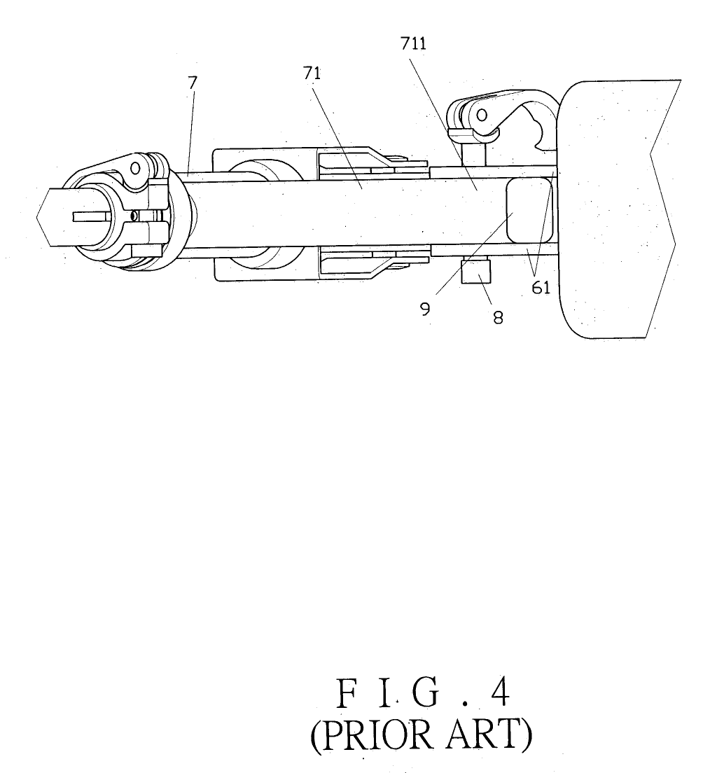

### DETAILED DESCRIPTION OF THE PREFERRED EMBODIMENT

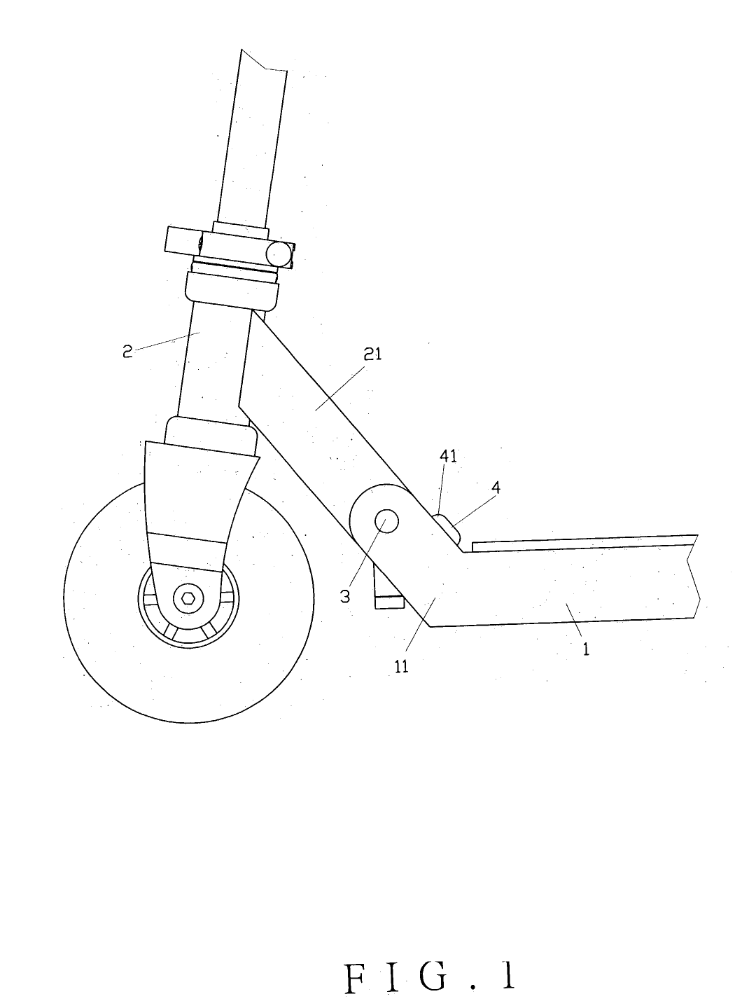

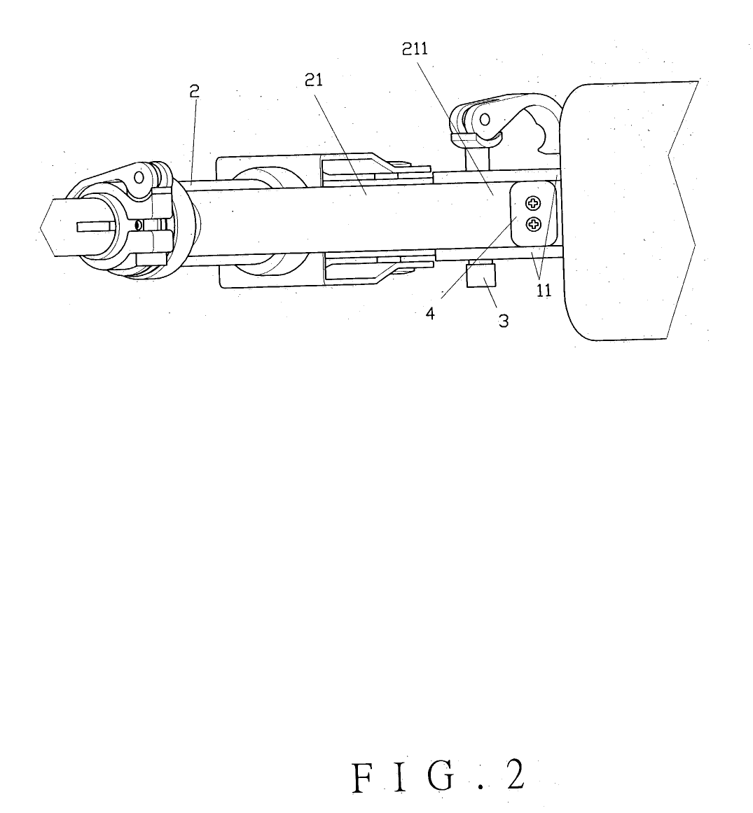

As shown in FIGS. 1 and 2, the present invention comprises a frame 1 and a front strut 2. The frame 1 has a pair of fork boards 11 at the front end thereof. The front strut 2 has a supporting rod 21 protruding from the lower end thereof. The supporting rod 21 comprises a connecting section 211 to be inserted into the fork boards 11 of the frame 1. Both the fork boards 11 and the connecting section 211 have holes corresponding with each other to be inserted by a shaft 3 to secure the connecting section 211 to the fork boards 11 of the frame 1 in a pivotal manner. A block 4 having rounded angles at four ends is secured to the connecting section 211 of the supporting rod 21 of the front strut 2.

The block 4 is so designed that when the supporting rod 21 of the front strut 2 is rotated downward or upward, the block 4 always covers the connecting area between the connecting section 211 and the fork boards 11 to prevent a user's finger from pinching.

1. A scooter folding structure comprising a frame and a front strut, said frame having a pair of fork boards with holes thereon, and said front strut comprising a supporting rod protruding from a lower end thereof, said supporting rod having a connecting section with holes corresponding to said holes of said fork boards of said frame, said connecting section being pivotally connected to said fork boards of said frame by a shaft;
said connecting section of said supporting rod of said front strut comprising a block to cover a gap between said connecting section and said fork boards of said frame.

2. The scooter folding structure as recited in claim 1, wherein said block comprises round and smooth surfaces at four ends, when lifting up or pushing down said front strut, said block remains at the position to cover the gap.
